(19) United States
(12) Patent Application Publication
(10) Pub. No.: US 2013/0271459 A1
(43) Pub. Date: Oct. 17, 2013

(54) Systems and methods of editing graphical data

(71) Applicant: Crocker Gary, San Diego, CA (US)

(72) Inventor: Crocker Gary, San Diego, CA (US)

(73) Assignee: IntegrityWare, Inc., San Diego, CA (US)

(21) Appl. No.: 13/447,116

(22) Filed: Apr. 13, 2012

(51) Int. Cl. G06T 17/00

(52) U.S. Cl. 345/420

(57) ABSTRACT

Systems and methods of updating graphical objects are disclosed. The methods and systems received polygonal data which describe discrete points on an object. A control mesh and a smoothed version of the control mesh are simultaneously displayed. When the control mesh is edited, the smoothed version is automatically updated by smoothing only a portion of the edited control mesh to generate a smoothed section, and replacing a portion of the smoothed version with at least a selected portion of the smoothed section.

### BACKGROUND

1. Field

The described technology relates to systems and methods of editing graphical information representing a polygonal data object.

2. Description of the Related Technology

Polygonal model data is created with, for example, a 3-D CAD software tool by, for example, a designer. The polygonal model or polygonal mesh includes discrete data points describing one or more surfaces or objects. The polygonal (or geometric) model, or data object, includes a number of geometries, such as vertices, edges, and faces. Polygonal models are convenient for design work at least because they define the surface or object with a degree of detail convenient for the designer to work with. The shape of the surface or object is defined by the data points, and the surface between the data points is perceived, but is not necessarily represented in the data. This allows for the CAD system to function quicker because of a significantly reduced data set representing the surface or object, while providing the designer enough detail to manipulate to achieve a desired design.

The polygonal data may be edited by a designer according to the designer's purposes. For example, the designer may add features to the object represented by the polygonal data using mesh operations. In addition, to create smooth, natural looking objects, a smoothing algorithm may be used to modify the polygonal data. For example, a Catmull-Clark algorithm or a Loop subdivision algorithm may be performed on the polygonal data. The smoothing algorithm modifies the polygonal data by, for example, adding vertices and repositioning existing vertices. Thus, the smoothing algorithm generates a modified object.

Typically the polygonal data is shown on a display with the smoothed object. as the designer edits the polygonal data in the design process, the smoothed object is updated to show the result of the designers edit.

In the editing process, much time may be used in precisely placing or moving each vertex. For 3-dimensional modeling, there are three degrees of freedom, but displays are 2 dimensional. Therefore, for each placement of a vertex, verification that the vertex is properly placed requires viewing the placed vertex and surrounding geometries from two or more different viewing perspectives.

### SUMMARY OF CERTAIN INVENTIVE ASPECTS

One aspect includes a method of producing an electronic geometric model with a computer system. The method includes accessing electronic data, where the data includes polygonal data defining a surface. The method also includes receiving a first indication from a user, where the first indication indicates that a portion of the control mesh is to be modified, and in response to a first indication, automatically calculating a surface in a region including the portion. The method also includes receiving a second indication from the user, wherein the second indication indicates a location of a geometry, and in response to the second indication, graphically representing the location in a perspective viewable to the user, and calculating a position of the geometry based on the location in the perspective and on the calculated surface, wherein the position is on the calculated surface.

### BRIEF DESCRIPTION OF THE DRAWINGS

FIG. 1 is an illustration of a polygonal data object having flow lines which may be improved.

FIG. 2 is an illustration of the polygonal data object of FIG. 1 having improved flow lines.

FIGS. 3A-3H are illustrations of a polygonal data object from two different perspectives at various stages of a method of editing the object.

### DETAILED DESCRIPTION OF CERTAIN INVENTIVE EMBODIMENTS

Various aspects and features of methods and systems are described herein with reference to the accompanying drawings, which show certain exemplary embodiments. The described embodiments may be modified in various ways, without departing from the spirit or scope of the present invention or inventions. In addition, the described embodiments have multiple features and aspects, no single one of which is solely responsible for the desirable characteristics of the embodiments. Furthermore, no single feature or aspect is essential to practicing the methods and systems described herein. Furthermore, various features and aspects of the embodiments may be combined in embodiments not specifically described.

Various inventive aspects of certain embodiments of methods and systems for generating and graphically rendering smoothed polygonal data objects are discussed. The methods and systems access polygonal data which describe discrete points of a geometric object. The methods and systems use a smoothing algorithm, such as, but not limited to, a Catmull-Clark or Loop subdivision algorithm to smooth the geometric object. The smoothed version of the polygonal data may be simultaneously displayed with a representation of the polygonal data. A designer may modify the polygonal data using a CAD software tool. As the polygonal data is modified, the smoothed version may be automatically updated in response to the modification of the polygonal data.

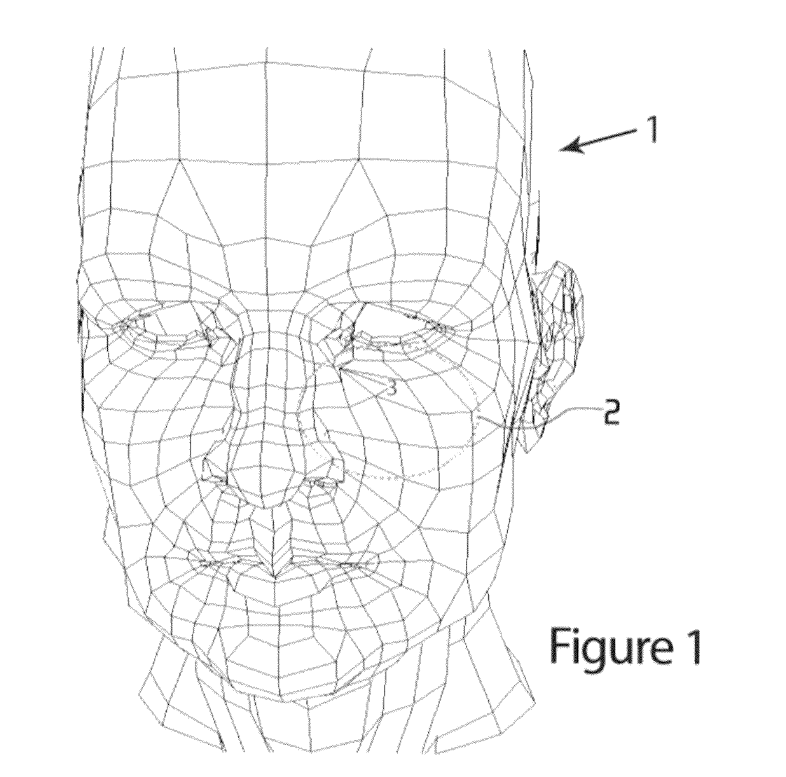

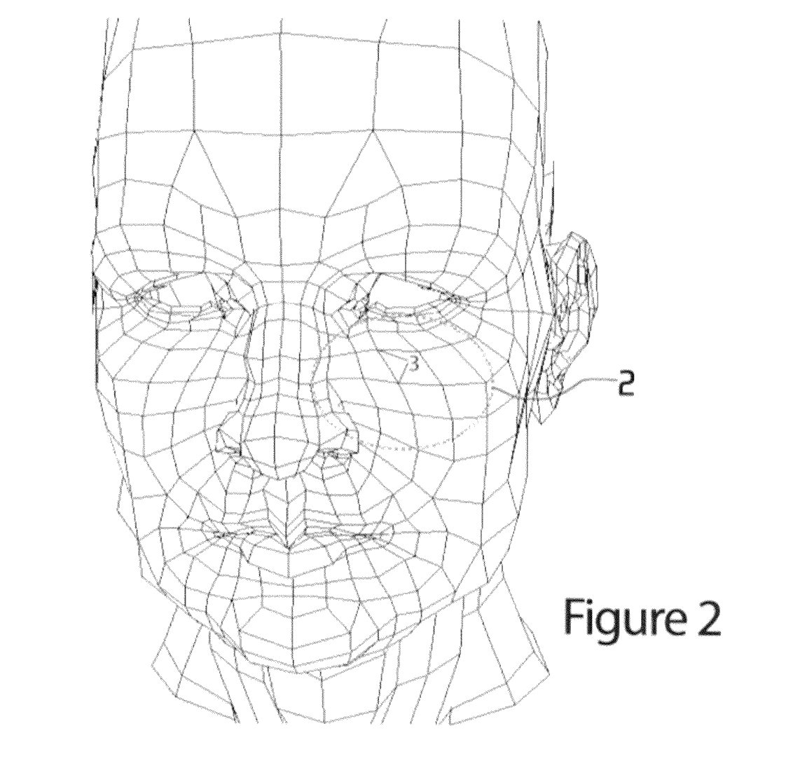

For example, the methods and systems may access electronic data which describes polygonal data object 1, such as that represented in FIG. 1. In this example, the polygonal data object 1 is a control mesh and a smoothed version of the control mesh is not shown. As shown, in a region 2, further editing may be done to improve the model. In this example, better flow lines may be generated by moving vertices 3. An improved model is shown in FIG. 2. As shown, in the region 2, vertices 3 have been moved, and the flow lines are improved as compared to that of FIG. 1.

In this example, the surface described by the geometries of FIG. 1 is accurate, but the flow lines could be improved. To make the improvements, a designer moves each of the vertices 3. Conventionally, moving a vertex while preserving the surface in the region of the vertex is difficult. Because the model represents a 3-dimensional object, moving a vertex requires the designer to verify that the movement is correct in all three dimensions.

During the modification, the designer controls the placement or modification of the vertices 3 so that the desired flow lines are produced. During the modification, the designer also controls the placement or modification of the vertices 3 so that the vertices 3 do not adversely affect the surface of the object because of being inadvertently placed inappropriately in a dimension unperceived by the designer. To prevent undesired modification of the surface shape, the designer must uses great care. To move a vertex, the designer makes many small movements and observes the results of the movements from each of two or more perspectives. Accordingly, the process is time consuming and prone to producing surfaces with undesired topology.

For improved designs, in some embodiments, the computer system constrains the placement of vertices to a calculated surface. Such constraint prevents placement of vertices in locations which would adversely affect the shape of the object.

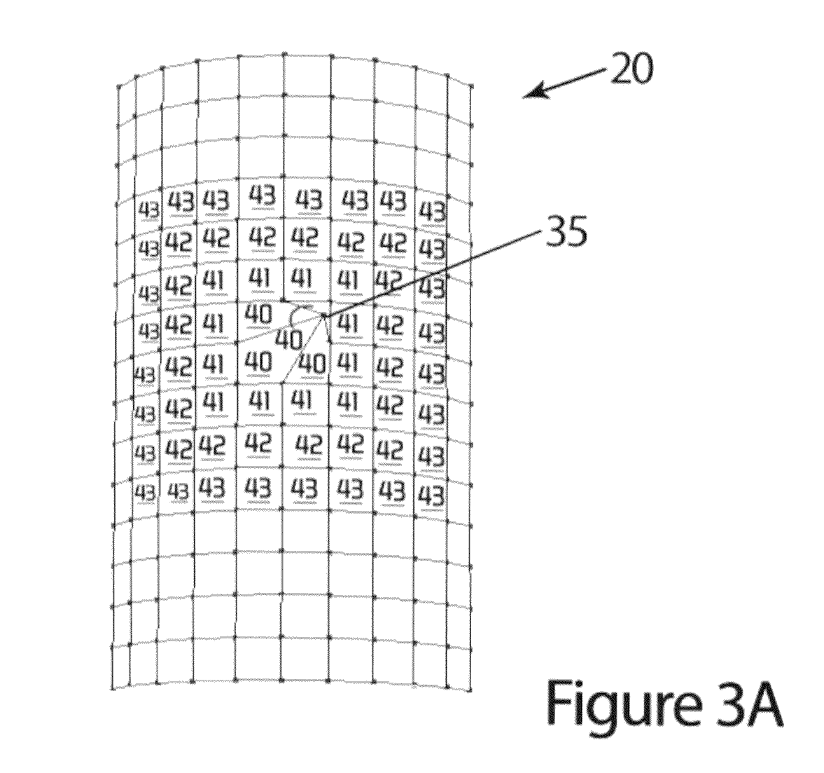

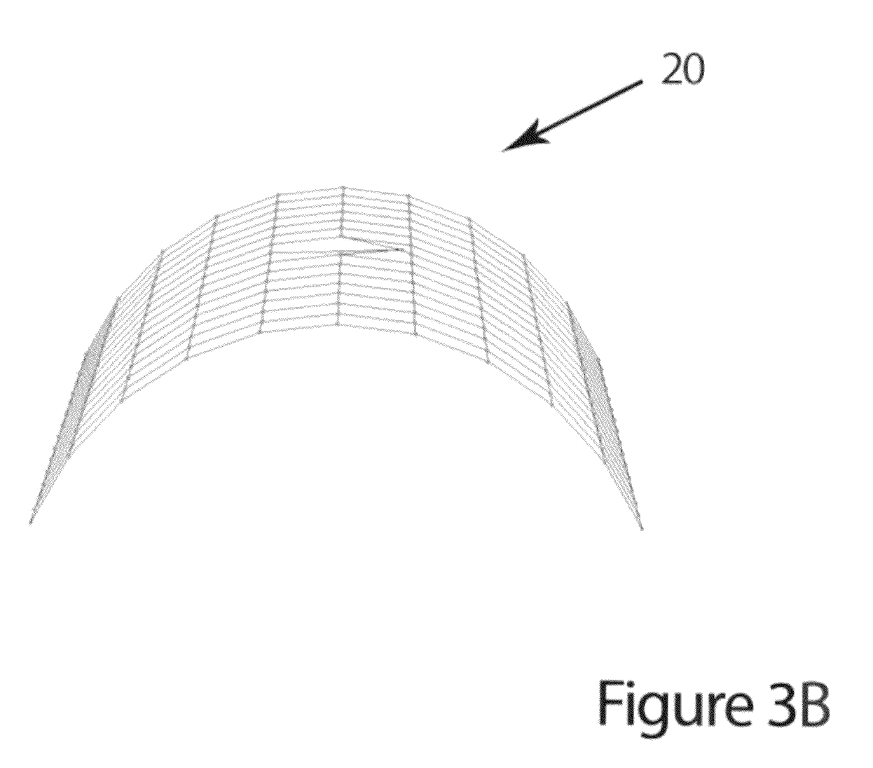

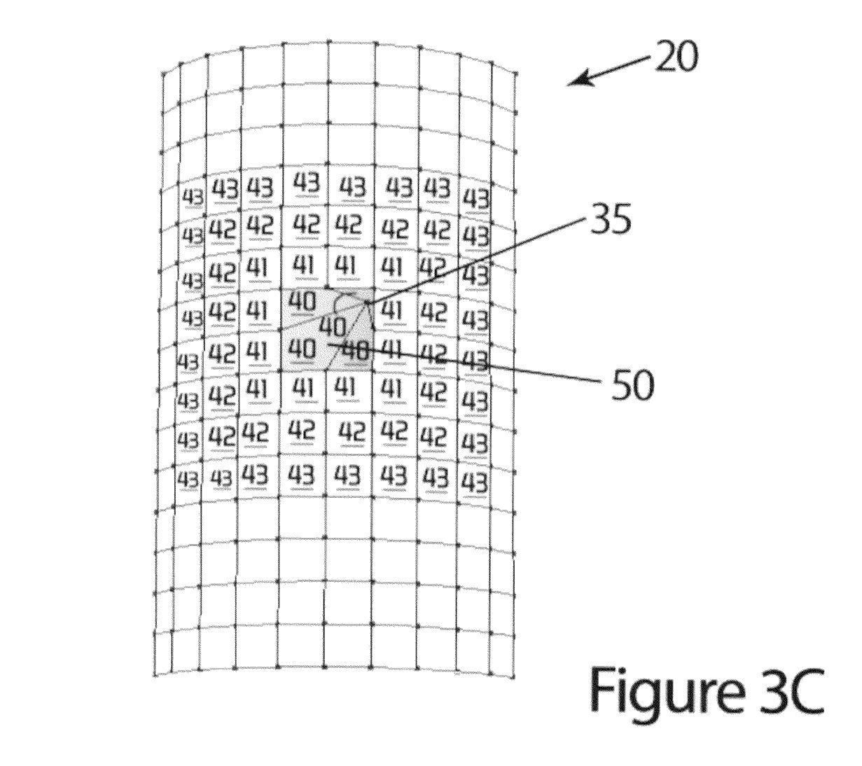

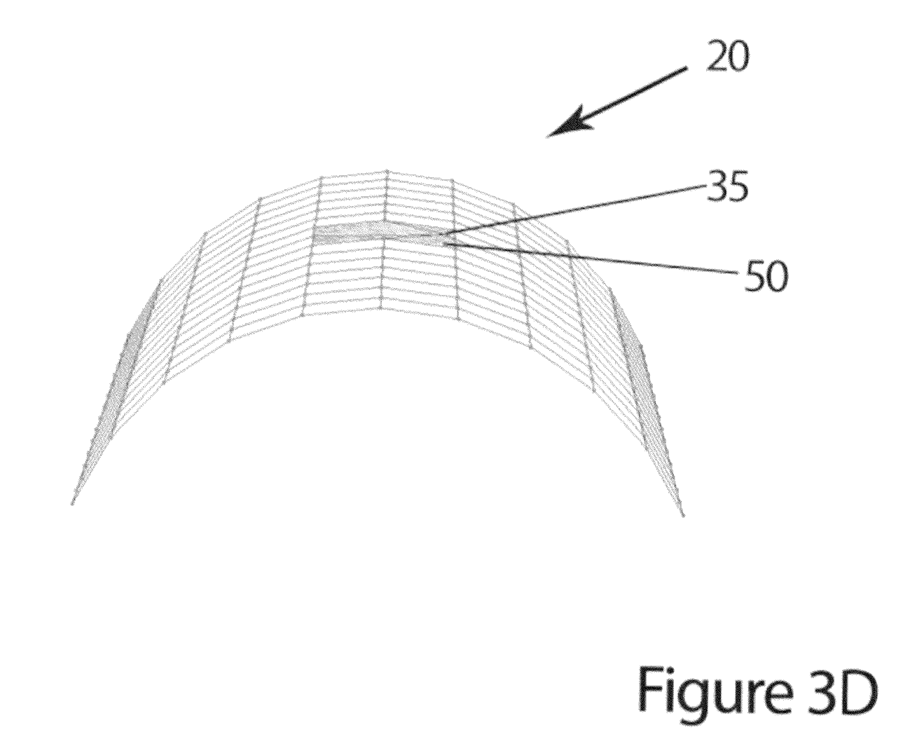

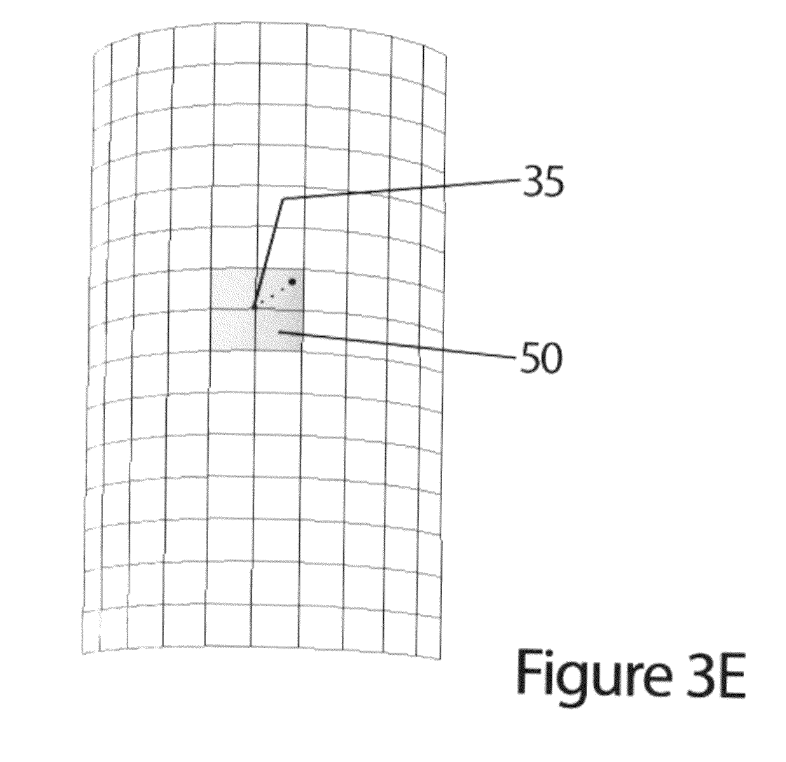

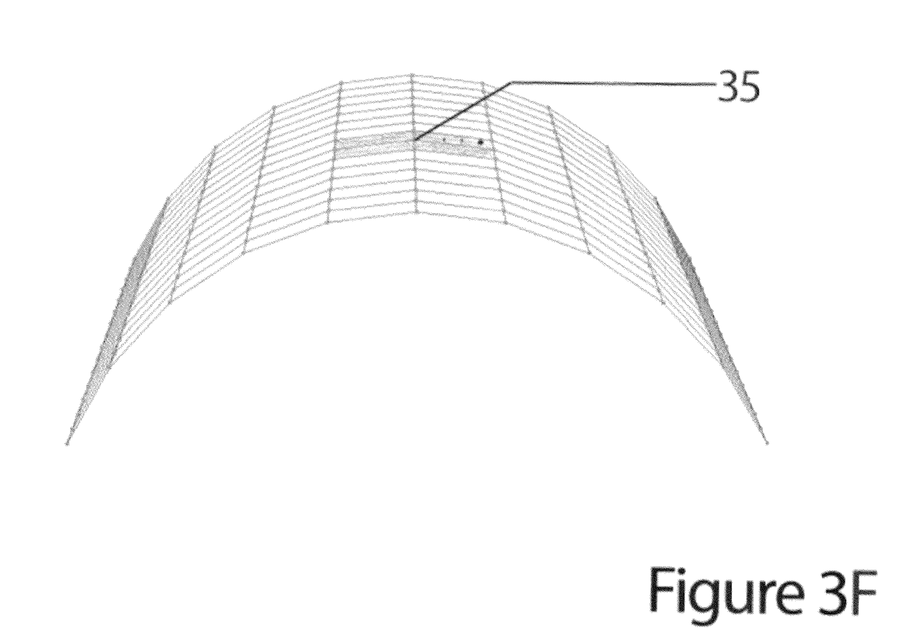

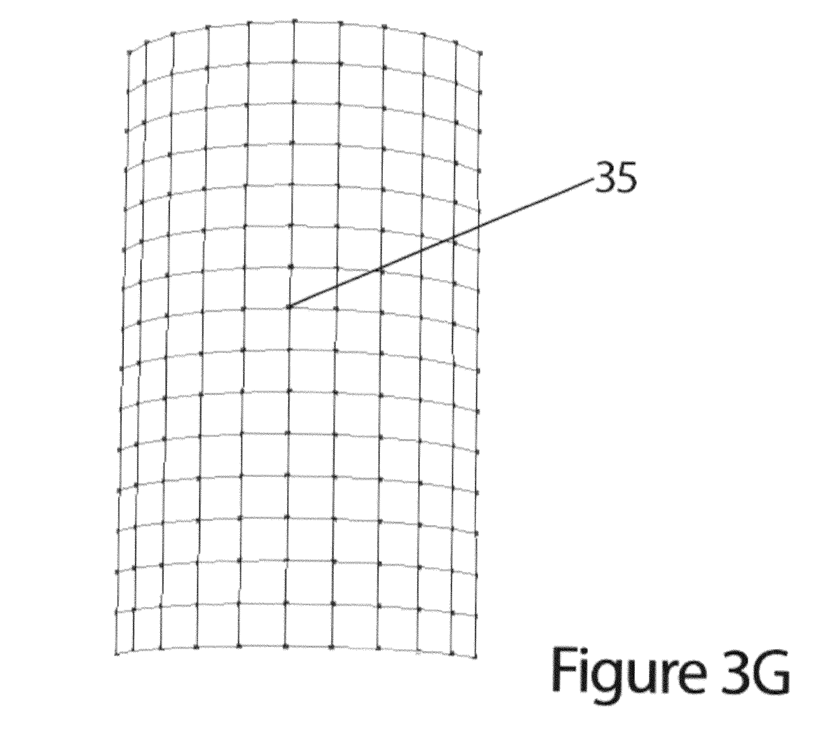

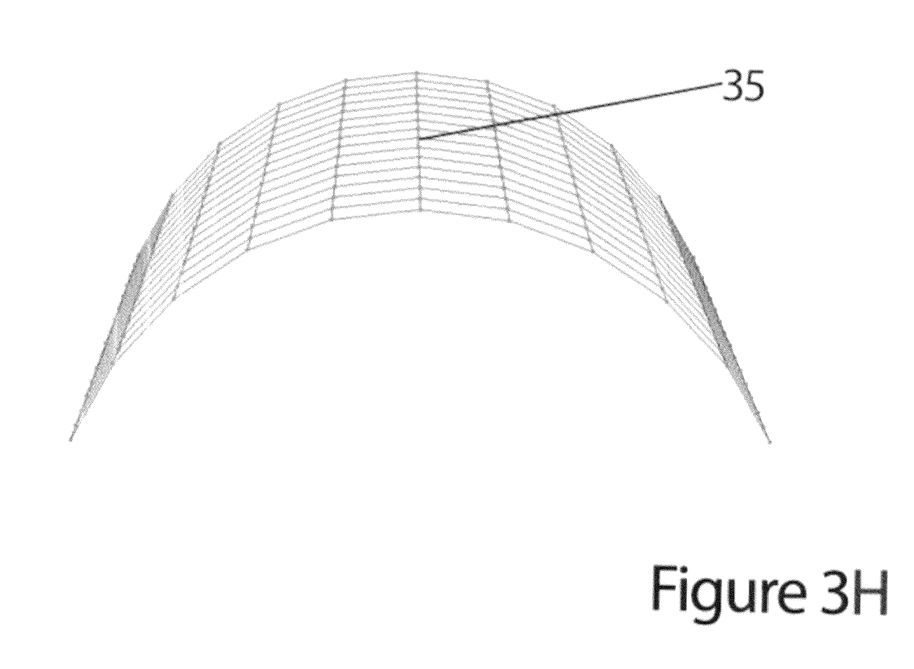

FIGS. 3A-3H are illustrations of a polygonal data object 20 from two different perspectives at various stages of a method of editing the object 20. The object 20 represents a curved surface on which all of the vertices lie. In FIGS. 3A and 3B, even though the vertex 35 is on the curved surface, the designer may prefer to move vertex 35, so that edges in the object 20 have a more uniform size and direction. In response to an indication from the designer, such as selecting the vertex 35, the computer system calculates a surface to which movement of the selected vertex 35 is constrained. In some embodiments, the surface may be calculated in response to an indication from the designer that a surfaced is needed in an indicated region of the object 20.

The computer system uses locations of nearby geometries, such as vertices, edges, and faces, to generate the surface according to, for example, a curve fitting algorithm, such as a linear extrapolation or a higher order fitting algorithm. The perimeter of the generated surface may be G0, G1, or G2 continuous with the data object 20. The surface generation algorithm is not limited. In some embodiments, one or more aspects of the methods of generating surfaces as described in U.S. patent application Ser. No. 13/027,092, entitled “methods and Systems for generating Continuous Surfaces from Polygonal Data,” filed on Feb. 14, 2011 and incorporated herein by reference is used. Any surface generation algorithm may be used.

In some embodiments, the computer system automatically selects the nearby geometries to use for generating the surface. For example, the designer may provide an indication as to which geometries are to be modified, and, in response to the indication, the computer system may select geometries of the polygonal data object which are near the geometries to be modified, and generate the surface based on the selected geometries.

In some embodiments, the geometries to be modified are included in the selected geometries. For example, the faces 40 of FIGS. 3A and 3B and their associated geometries which are to be modified by the movement of vertex 35, may be selected by the computer system for generating the surface. In some embodiments, the computer system excludes the geometries to be modified.

In some embodiments, the computer system selects geometries which are adjacent to the geometries to be modified. For example, the faces 41 of FIG. 3A may constitute and additional ring of faces and associated geometries which are selected by the computer system. Any number of additional rings, such as rings of faces 42 and 43 may be selected. In some embodiments, three rings are used. In such embodiments, the surface generated based on the three rings is smooth, continuous, and approximates the local surface of the data in the region near the vertex 35.

In some embodiments, in the process of selecting geometries for generating the surface, the computer system may determine that the data object includes a sudden significant topological change. For example, if a gradient along a path from the geometries to be modified is greater than a threshold, the computer system may not include the geometries of the topological change.

In some embodiments, the designer may select or exclude certain geometries. in some embodiments, the designer may provide an indication to the computer system to exclude certain geometries for generating the surface. For example, for data objects which include a sudden drastic topological change, if geometries which are to be modified are near the topological change, the designer may indicate to the computer system to not use the geometries forming the change. The designer may include or exclude geometries for various other reasons.

FIGS. 3C and 3D are illustrations of data object 20 and a surface 50 which the computer system has generated as discussed above. In the embodiment, the surface 50 is confined to the faces 40 which are associated with vertex 35. In other embodiments, the generated surface extends beyond the faces affected by the movement of a vertex. For example, the surface may be generated to extend so as to include faces 41, 42, or 43. In some embodiments the generated surface extends to include a portion of one or more faces. In some embodiments, the computer system generates a representation of the surface which is perceivable by the designer. Alternatively, the surface may be calculated to constrain the movement of the vertex 35 without being graphically displayed.

FIGS. 3E and 3F are illustrations of data object 20 and a surface 50 where vertex 35 has been moved to improve the model. Also shown is a path the designer may use to move the vertex 35 from its previous position, as shown in FIGS. 3A-3D, to its new position, as shown in FIGS. 3E and 3F. Because of the containing surface 50, the designer can confidently move the vertex 35 to its new position and be sure that the moved vertex 35 does not adversely alter the shape of the surface defined by data object 20. Because of the constraining surface, a single 2-dimensional perspective, such as that shown in FIG. 3E is sufficient graphical information for the designer to be confident that the vertex 35 has proper placement in all three dimensions. Also, because of the constraining surface, to reposition the vertex 35, the designer makes a single movement of the vertex 35 from its previous position to the improved position, where the movement is linear or approximately linear at least in the 2-dimensional perspective displayed by the computer system.

FIGS. 3G and 3H are illustrations of data object 20 where vertex 35 has been moved to improve the model. As shown from the two perspectives, the movement of vertex 35 has improved the model substantially without modifying the surface represented by data object 20.

The various aspects, process, and actions discussed herein may be performed sequentially or in parallel. For example, a system capable of parallel processing may divide certain procedures among the available processing devices. In addition, the various aspects, processes, and actions may be performed automatically or algorithmically by the computer system according to a program running on the computer system.

While various aspects, processes, actions and systems have been described as being included in the embodiments discussed, the various aspects, processes, actions, and system can be practiced with certain modification. For example, the sequential order of the various aspects, processes, and actions may be modified. In addition, certain aspects, processes, and actions may be omitted, and other aspects, processes, and actions may be added.

What is claimed is:

1. A method of producing an electronic geometric model with a computer system, the method comprising:
accessing electronic data, the data comprising polygonal data defining a control mesh for a geometric model;
receiving a first indication from a user, wherein the first indication indicates that a portion of the control mesh is to be modified;
calculating a surface in a region of the control mesh, the region including the indicated portion;
receiving a second indication from the user, wherein the second indication indicates a location for a geometry of the control mesh; and
in response to the second indication, graphically representing the geometry in the location in a perspective viewable to the user, and calculating a position for the geometry in the control mesh based on the location in the perspective and on the calculated surface, wherein the position is on the calculated surface.

2. The method of claim 1, wherein the surface is calculated in response to the first indication.

3. The method of claim 1, wherein the surface is calculated in response to a third indication.

4. The method of claim 1, wherein the surface is calculated according to a curve fitting algorithm.

5. The method of claim 1, wherein the surface is calculated based on selected geometries of the control mesh, wherein the selected geometries include geometries which are adjacent to the indicated portion.

6. The method of claim 5, wherein the selected geometries include geometries of the indicated portion.

7. The method of claim 5, wherein the selected geometries include geometries which are no more than a predetermined number of faces from the indicated portion.

8. The method of claim 7, further comprising calculating a gradient along a plurality of paths from the indicated portion, wherein the selected geometries exclude geometries which are beyond a section of the path having a gradient greater than a threshold.

9. The method of claim 5, wherein the selected geometries include geometries which are no more than three faces from the indicated portion.

10. The method of claim 5, further comprising receiving an indication from the user indicating that a particular geometry is to be included in the selected geometries.

11. The method of claim 5, further comprising receiving an indication from the user indicating that a particular geometry is to be excluded from the selected geometries.

12. The method of claim 1, wherein the surface is G0, G1, or G2 continuous with the control mesh.

13. The method of claim 1, further comprising generating a representation of the surface which is perceivable by the user.

14. The method of claim 1, wherein the surface is not graphically displayed.
